(19) United States
(12) Patent Application Publication
(10) Pub. No.: US 2008/0162336 A1
(43) Pub. Date: Jul. 3, 2008

(54) Shared Appreciation Mortgage Loan System and Method

(76) Inventor: Richard Jaffee, Weston, CT (US)

Correspondence Address: RUBENSTEIN & GLAZER, LLC, ONE MORNINGSIDE DRIVE, NORTH, BUILDING A, WESTPORT, CT, 06860, US

(21) Appl. No.: 11/616,978

(22) Filed: Dec. 28, 2006

(51) Int. Cl. G06Q 40/00

(52) U.S. Cl. 705/38

(57) ABSTRACT

The present invention is a shared appreciation mortgage (SAM) loan finance system which establishes for a shared appreciation mortgage loan: a term (n); an interest rate (rᵢ); a value of a real property at the time of origination of the SAM loan (vₒ); a borrower's invested equity (e_{b}); a loan to value (k); a predicted annual housing appreciation rate (rₕ); an expected average annual rate of return (rₑ); a shared appreciation rate (rₐ); and vested appreciation mortgage loan balances comprising: a SAM loan principal balance (p); a first mortgage loan principal balance (f); a whole-equity balance; a borrower's invested equity balance (e_{b}); a shared appreciation equity balance (eₛₐ); a SAM loan accrued interest balance (a); a shared appreciation equity balance (eₛₐ); and a shared appreciation mortgage lender's share (x) of said shared appreciation equity balance; wherein the system provides for deferral of all payments of shared appreciation mortgage loan principal and SAM loan accrued interest until the maturity date.

### FIELD OF THE INVENTION

The present invention relates generally to the financing of real property and more particularly to a system and method for implementing a shared appreciation mortgage loan for financing residential or commercial real estate.

### BACKGROUND OF THE INVENTION

Many kinds of mortgage loans have been developed for financing real property whereby a lender loans money to a borrower who agrees to pay the loan back, with interest, over a period of time, with the loan being collateralized by a mortgage granted from the borrower to the lender. Typically, the borrower is required to make periodic, usually monthly, payments of principal and interest to the lender until the entire loan, with accrued interest, is paid off. Some of the different kinds of available mortgage loans are the adjustable rate mortgage (ARM), the graduated payment mortgage (GPM), the price level adjusted mortgage (PLAM) and the shared appreciation mortgage (SAM), each of which is described in further detail in U.S. Pat. No. 6,904,414 by Madden, which is incorporated herein by reference.

Variations of Shared Appreciation Mortgages, or SAMs, have been available since at least as early as the 1980s. There are many varieties of shared appreciation mortgages but they all provide the lender compensation in the form of a share of the appreciated value of the real estate over a period of time. Many varieties of SAM loans have been introduced, but to date, none have been widely adopted in the market place. Much of the unpopularity of prior art SAMs may be attributable to their high cost in terms of the appreciation the borrower forfeits relative to the monthly savings the SAMs could provide. For example, many prior art SAM products provide a slight discount in the interest rate in exchange for the lender's share of appreciation at the end of the loan, but they still require the borrower to make substantial payments of interest and/or principal either throughout the entire term of the loan or sometimes with one or the other being deferred on a short term basis.

Moreover, prior art SAMs have failed to achieve a preferred balance of risk and benefit to both borrower and lender. Prior art SAMs failed to shield the borrower's invested equity from the reach of the lender in terms of the lender's interest compensation and the lender's appreciation interest. In addition, the prior art SAM products based the lender's appreciation share on a full value of the real estate, with few or no deductions before the lender's appreciation share is calculated.

### SUMMARY OF THE INVENTION

The present invention is a novel shared appreciation mortgage loan system and method for implementing the system using a computer system.

The present mortgage finance system allocates risks, costs and compensation in a manner that is more attractive to both SAM lender and borrower than was possible with previous SAM loans. The present invention provides the SAM lender a means to target a minimum rate of return along with the possibility of greater compensation in terms of shared appreciation. The borrower, for the first time, can enjoy the benefits of totally deferred costs in addition to a reduction of the downside risk associated with prior art SAM loans while still sharing with the SAM lender in the upside of real estate appreciation.

The present shared appreciation mortgage finance system provides a mortgage loan in which the appreciation equity is calculated in a novel way. The present system also provides a novel algorithm for producing the rate at which the SAM lender is entitled to share in the appreciation equity. In addition, the present system divides the payment obligations of the borrower and, conversely, the compensation interests of the SAM lender into prioritized segments with the SAM lender's and borrower's interests vesting in successive priorities in a novel fashion. The present system also provides a mortgage loan where all of the borrower's payments of principal and interest to the SAM lender are deferred until maturity.

Upon maturity of the SAM loan, the present value of the mortgaged property is assessed in order to determine the total available funds from which the prioritized, vested interests of the borrower and lender may be drawn. Before the SAM loan participants are paid, any outstanding first mortgage principal balance is paid or set aside. Next, the SAM lender collects the SAM loan principal balance, for which all payments had been deferred over the term of the loan. Next, the borrower's invested equity in the mortgaged real estate asset is set aside or paid back to the borrower out the sale proceeds. Then, out of the remaining funds, if sufficient, the SAM lender collects the accrued deferred interest on the SAM loan principal balance. Finally, after all of the above mentioned priority balances have been paid or accounted for, the remaining balance is deemed the shared appreciation equity. The lender and the borrower are then each entitled to their respective percentage interests in the shared appreciation equity.

The deferred payment of principal and interest provided by the present system is of great advantage to the borrower, who has use of funds over the term of the loan which he would not have under most conventional loans and may therefore afford a more expensive house or enjoy lower monthly payments. Moreover, the borrower's deferred accrued interest and shared appreciation obligations to the SAM lender are reduced and possibly extinguished in the event there is little or no appreciation in value of the underlying real estate. Unlike prior art systems, the present system does not merely subtract the purchase price from the sale price and provide the SAM lender with a percentage thereof after having collected interest and principal payments from the borrower throughout the term of the loan. All priority balances must be paid or set aside before the deferred accrued interest is paid to the SAM lender and before the shared appreciation equity is determined. In this way, the present system also preserves the borrower's invested equity from the reach of the SAM loan for anything but the repayment of SAM loan principal balance upon the maturity date.

The present invention also includes a method for implementing the appreciation mortgage system using a computer system. The method comprises entering borrower data, lender data, loan data, and system variables into a computer system; calculating compensation factors by means of the computer system; and producing, via the computer system, loan documents effecting a shared appreciation mortgage loan employing the present shared appreciation mortgage system. At maturity, maturity data may be entered into the computer system to calculate payoff data and the distribution of proceeds according to the prioritized available balances.

The present mortgage finance system is available to finance, optionally, a portion of the purchase of residential real estate or to refinance an existing mortgage or mortgages on residential real estate. Optionally, the shared appreciation mortgage system may also be used for the finance or refinance of residential, single family, multifamily or commercial real estate and may comprise a first mortgage loan, a second mortgage loan or both.

The present system has the versatility to be adopted for use in, inter alia, residential, multifamily and commercial lending. Where differences exist between residential lending and commercial lending, one skilled in the art will know how to adopt the finance system of the present invention to either. The flexibility of the present system allows the lender to adjust the compensation factors based on the nature of the real estate being financed by, inter alia, adjusting the loan to value ratio, adjusting the interest rate and/or adjusting the shared appreciation rate. The present system may be particularly well-suited for financing certain investment properties which produce an income stream for the borrower/investor. Generally, commercial properties produce a certain amount of operating income for the borrower/investor, out of which is paid the mortgage finance expense. A reduction in mortgage finance expenses will correlate to an increase in net income for the borrower/investor. In this case, the lower monthly payments provided by the present system will reduce the mortgage finance expense and, therefore, will correlate to higher net income for the borrower/investor. It is likely that borrower/investors will appreciate the trade off of a portion of a speculative appreciation in real estate value over a long period for an immediate, certain increase in net income. The foregoing, in combination with certain tax considerations, may make the borrower/investor less dependent on appreciation in the real estate value over the term of the loan.

In light of the foregoing, and merely for simplicity, this specification will describe the present finance system in terms of a residential second mortgage loan in combination with a first mortgage loan.

These and other improvements will be apparent to one skilled in the art based on the following detailed description.

### BRIEF DESCRIPTION OF THE DRAWINGS

FIG. 1 illustrates vesting of the prioritized balance segments following high real estate appreciation over the term of the SAM loan.

FIG. 2 illustrates vesting of the prioritized balance segments following moderate real estate appreciation over the term of the SAM loan.

FIG. 3 illustrates vesting of the prioritized balance segments following low real estate appreciation over the term of the SAM loan.

FIG. 4 illustrates vesting of the prioritized balance segments following moderate real estate depreciation over the term of the SAM loan.

FIG. 5 illustrates how, for a preferred embodiment under certain conditions, the two portions of the SAM lender's compensation may be funded out of the difference between the sale's price and the purchase price.

Note that none of the figures are drawn to scale with regard to the proportion of one balance in relation to another.

### DETAILED DESCRIPTION OF THE INVENTION

The present invention comprises a mortgage finance system and a method for implementing the system using a computer system.

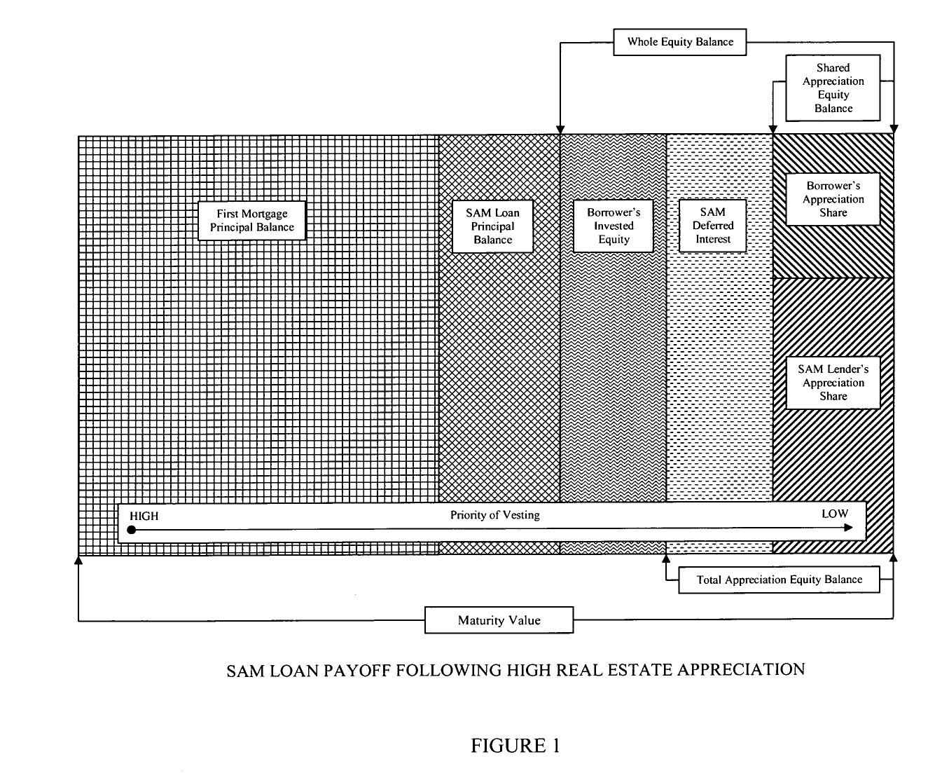

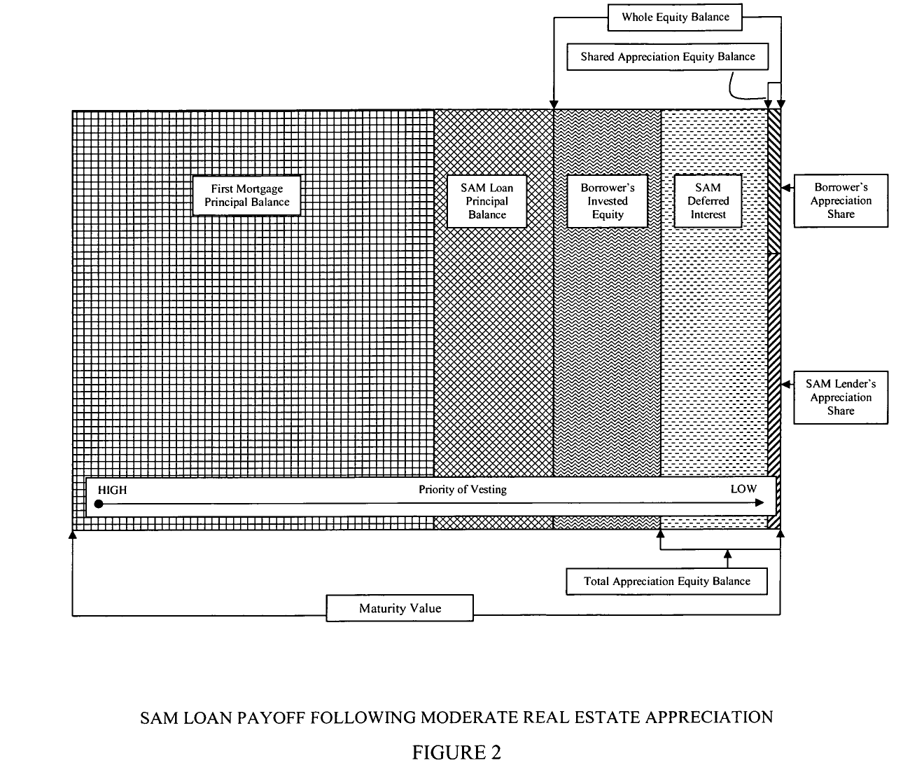

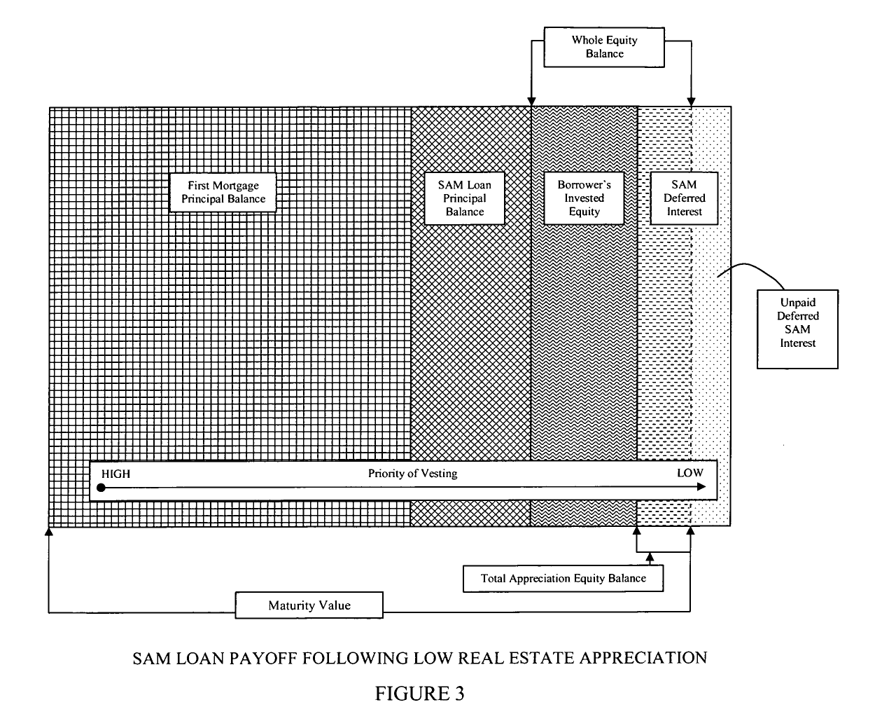

As shown in FIGS. 1-4, the present system divides the value of the real estate upon maturity, the maturity value, into several prioritized segments comprising a first mortgage principal balance, a SAM loan principal balance, a whole equity balance comprising a borrower's invested equity balance and a total appreciation equity balance comprising a deferred SAM interest balance and a shared appreciation equity balance comprising a lender's appreciation share based on the shared appreciation rate and a borrower's appreciation share.

The borrower's repayment obligations comprise the SAM lender's interests in the principal balance, the accrued deferred SAM interest and the lender's appreciation share, which interests preferably are effected by written instruments comprising a promissory note and the equivalent of a mortgage deed. Collectively, the segmented, prioritized balances are referred to as the SAM mortgage balances.

The present system allows the borrower to defer all payments of SAM interest and SAM principal until the maturity date. The maturity date is a specific date after a period of time, preferably a number of years, on which the SAM mortgage balances are repaid, which date is set forth in the financial instruments and defined as the “term.” The term may be any period of time, preferably a number of years or months. More preferably, the term is 5 years, 10 years, or 20 years with 10 years being most preferable. The term of the SAM loan may be established independently from the term of any first mortgage loan. In the event of a sale of the real estate prior to the expiration of the term, the maturity date is the date on which the real property is sold. Thus, all payments to the SAM lender are deferred until the maturity date, which is at the end of the term the earlier date of sale of the real estate.

The present system may also make provisions for the pre-payment of the SAM loan, that is, when the borrower pays off the SAM loan prior to the end of the term and without sale of the real estate (payment upon sale of the real estate does not constitute prepayment). In case of pre-payment, the present system may impose a pre-payment penalty which may be structured and implemented to deter the borrower from taking advantage of any downturn in the value of the mortgaged real estate to avoid or reduce payment of accrued SAM interest and/or shared appreciation. The prepayment penalty may optionally become due any time the loan is prepaid or may, preferably, be structured to provide compensation to the SAM lender only if the SAM loan is prepaid when the total appreciation balance is insufficient to fund a minimum shared appreciation equity balance or to pay all or part of the accrued SAM interest. If prepayment follows a sharp increase in real estate value, inherent features of the present invention provide the SAM lender with adequate compensation, even without a prepayment penalty. In any case, the prepayment penalty may comprise a percentage of the SAM loan principal balance, where the percentage is based on, and positively correlated to, the term remaining. The prepayment penalty may also, optionally, comprise a revision to the maturity value. Many other methods for determining an appropriate prepayment penalty are known in the art.

In a preferred embodiment, no pre-payment penalty will apply unless the borrower refinances the SAM loan in the first three years. In that case, the prepayment penalty will be an amount equal to the higher of either the proceeds from the distribution from the prioritized balance segments or interest on the SAM loan principal balance at the SAM interest rate plus an additional 2% per year. No prepayment penalty will be due after 3 years have elapsed; all SAM loan terms will convert thereafter to the prioritized balance segment funding.

The Shared Appreciation Rate

The percentage of the shared equity to which the SAM lender is entitled, also known as the shared appreciation rate, is determined by using a novel algorithm which takes into consideration a number of variables, several of which are based on assumptions available at the origination of the SAM loan. The shared appreciation rate provided through the algorithm is predicted to produce an expected rate of return over the life of the SAM loan.

$${r}_{a} = \frac{( p \cdot {r}_{e} \cdot n ) - ( p \cdot {r}_{i} \cdot n )}{( {v}_{o} \cdot ( 1 + {r}_{h}^{n} ) - {v}_{o} ) - ( p \cdot {r}_{i} \cdot n )} \qquad Formula 1$$

Where:
rₐ=shared appreciation rate (SAR)
p=SAM loan principal balance
vₒ=value of real estate at origination of SAM loan
n=term
rᵢ=SAM loan interest rate
rₕ=predicted annual housing appreciation rate
rₑ=SAM lender's expected rate of return

The predicted housing appreciation rate is the rate at which the mortgaged real estate is predicted to appreciate in value, preferably on an annual basis. This rate may be established by the SAM lender based on any number of models for predicting future real estate appreciation. Different housing appreciation rates may apply to different geographical areas, based on the sophistication and detail of the models selected by the SAM lender. While there are currently publicly available historical and predicted housing appreciation models, the SAM lender using the present system may wish to employ its own proprietary modeling system for predicting future real estate values and use such predicted appreciation rate in the algorithmic calculations.

Optionally, the SAM lender may use a predicted term, in substitution for the actual term of the loan, for calculations of the shared appreciation rate or other variable. For example, it is reported that, currently, the average home loan is paid off in approximately 5.5 years even though most frequently first home mortgage loans are for a term of 30 years. Thus, even if the specified term of the SAM loan is 15 years, for example, the SAM lender can employ relevant statistical data regarding the life of real estate loans, in substitution for the actual 15 year term, to calculate the shared appreciation rate or any other system variables.

The current system provides the borrower and the SAM lender an improved means for negotiating and allocating some of the interest rate risk and credit risks between the parties. Many performance characteristics of the present loan may be analyzed and predicted by using the system algorithm to solve for different loan variables or compensation factors. In this regard, actual, assumed and predicted conditions at the origination of the loan may be employed during negotiation of SAM loan terms, such as the principal balance, the term, the interest rate, and the shared appreciation rate, so that the SAM lender is satisfied with its expected rate of return and risk profile and the borrower maximizes the benefits of deferred payments and any upside in the real property appreciation. The present system provides the SAM lender a means for targeting a consistent predicted rate of return across different interest rate and housing market environments.

As just one example of the effect of changing a system variable, for the same expected average rate of return, when the SAM loan interest rate goes up, the SAR goes down, and so does the portion of the total appreciation equity balance which the SAM lender shares with the borrower. This application of the present system would provide the lender generally with a more certain overall return, with less speculation that the expected rate of return will be achieved through a predicted rate of appreciation in the value of the real estate. Alternatively, the SAM lender may lower the SAM interest rate and raise the SAR, for example where the predicted rate of housing appreciation is high. This application of the present system would also have the effect of back-loading the SAM lender's prioritized return into the shared appreciation equity segment to provide a greater opportunity to capitalize on a high or higher than predicted appreciation rate. Many other results may be achieved though permutations and manipulation of the various loan parameters as will be obvious to one skilled in the art.

The Expected Rate of Return

Another application of the algorithm of the present system is to determine an expected rate of return for the SAM lender, using certain known and predicted variables around the time of origination of the SAM loan. The following formula can be used to predict the SAM lenders annualized rate of return.

$${r}_{e} = \frac{( ( {v}_{o} \cdot {( 1 + {r}_{h} )}^{n} - {v}_{o} ) - ( p \cdot {r}_{i} \cdot n ) ) \cdot {r}_{n} + ( ( p \cdot {r}_{i} \cdot n )}{( n \cdot p )} \qquad Formula 2$$

Where:
rₐ=shared appreciation rate (SAR)
p=SAM principal balance
vₒ=value of real estate at origination of SAM loan
n=term
rᵢ=SAM loan interest rate
rₕ=predicted annual housing appreciation rate
rₑ=SAM lender's expected rate of return

The SAM Loan to Value

Another variable that may be controlled for by the present system is the SAM loan to value. Within practicable parameters, the SAR is positively correlated to the SAM loan to value. The SAM loan to value is equal to the SAM loan principal balance divided by the value of the real estate at origination. (Stated another way, the SAM loan principal balance is equal to the SAM loan to value multiplied by the value of the real estate at the origination of the loan.) Where the SAM loan to value rises above a threshold level, the SAM loan may become impracticably expensive for the SAM borrower. The SAM loan to value may be a variable which can be selected by the borrower directly (or indirectly through the principal amount borrowed in relation to the initial value of the real estate) to lower or maintain an acceptable shared appreciation rate. The SAM loan to value preferably comprises 30% or less. More preferably, the SAM loan to value comprises 25% or less. Even more preferably, the appreciation loan to value comprises between 5% and 20%, with the most preferred appreciation loan to value comprising either 10% or 15%.

$$k = \frac{p}{{v}_{o}} \qquad Formula 3$$

Where
k=SAM loan to value (LTV)
p=SAM principal balance
vₒ=value of real estate at origination of SAM loan

$$k = \frac{{r}_{h} ( {v}_{o} \cdot {( 1 + {r}_{h} )}^{n} - {v}_{o} )}{n \cdot {v}_{o} ( {r}_{e} - {r}_{i} - {r}_{a} {r}_{i} )} \qquad Formula 4$$

Where
k=SAM loan to value (LTV)
rₐ=shared appreciation rate (SAR)
vₒ=value of real estate at origination of SAM loan
n=term
rᵢ=SAM loan interest rate
rₕ=predicted annual housing appreciation rate
rₑ=SAM lender's expected rate of return

### EXAMPLE 1

As this example shows, the shared appreciation rate which will provide an expected rate of return increases dramatically as the loan to value rises as all other loan variables remain constant.

Where
rₐ=shared appreciation rate (SAR)
k=SAM loan to value (LTV)
vₒ=$500,000
n=5 years
rᵢ=10%
rₕ=3.0%
rₑ=14.40%
vₘₚ=predicted value of real estate at maturity=$579,637

TABLE 1

| LTV (k) | SAR (rₐ) |
|---|---|
| 1% | 1.43% |
| 2% | 2.95% |
| 3% | 4.58% |
| 4% | 6.32% |
| 5% | 8.19% |
| 6% | 10.21% |
| 7% | 12.39% |
| 8% | 14.76% |
| 9% | 17.33% |
| 10% | 20.13% |
| 11% | 23.21% |
| 12% | 26.59% |
| 13% | 30.34% |
| 14% | 34.50% |
| 15% | 39.16% |
| 16% | 44.40% |
| 17% | 50.35% |
| 18% | 57.16% |
| 19% | 65.03% |
| 20% | 74.23% |

### EXAMPLE 2

As this example shows, for a given shared appreciation rate, the SAM lender's expected return falls dramatically as the SAM LTV rises as all other variables remain constant.

Where
rₐ=20.13%
k=SAM loan to value (LTV)
vₒ=$500,000
Vₘₚ=$579,637
n=5 years
rᵢ=10%
rₕ=3.0%
rₑ=SAM lender's expected annual rate of return

TABLE 2

| LTV (k) | rₜ |
|---|---|
| 1% | 72.11% |
| 2% | 40.05% |
| 3% | 29.36% |
| 4% | 24.02% |
| 5% | 20.81% |
| 6% | 18.67% |
| 7% | 17.15% |
| 8% | 16.00% |
| 9% | 15.11% |
| 10% | 14.40% |
| 11% | 13.82% |
| 12% | 13.33% |
| 13% | 12.92% |
| 14% | 12.57% |
| 15% | 12.26% |
| 16% | 11.20% |
| 17% | 11.76% |
| 18% | 11.55% |
| 19% | 11.36% |
| 20% | 11.19% |

Preferably, the borrower is required to have at least a minimum equity stake in the real estate being financed by the SAM loan. Optionally, the SAM lender may require the borrower's initial equity be at least equal to the SAM loan principal balance such that the borrower's initial equity is sufficient collateral for the SAM lender's prioritized claim to the SAM loan principal balance. When the present system comprises a first mortgage loan and second SAM mortgage loan, the combined loan to value may be limited by first mortgage considerations, independently from the SAM loan to value.

### DESCRIPTION OF A PREFERRED EMBODIMENT OF THE INVENTION

When the real estate is sold, the sales price determines the maturity value. Upon the sale of the real estate, before payments are made on any appreciation mortgage balances, any outstanding first mortgage loan principal balance is paid out of the maturity value according to the terms of such first mortgage loan, preferably from the proceeds of the sale. Any other first mortgage obligations, for example pre-payment penalties, accrued interest up to the closing date, closing fees, or the like, are to be paid by the borrower outside of the present system.

The borrower's next payment obligation is repayment of the SAM loan principal balance. The SAM principal balance comprises the amount financed through the SAM loan. As noted previously, all payments of SAM loan principal and interest are deferred until the SAM loan's maturity, so this payment is the first receipt-of-payment event for the SAM lender. Repayment of the SAM loan principal balance lender takes priority immediately following payment of any first mortgage obligations and before any further disbursement is to be made out of the proceeds of the sale either to, or on behalf of, the borrower. The SAM lender's interest in the SAM loan principal balance vests upon payment of the first mortgage obligations.

According to the present invention, the first mortgage loan principal balance and the SAM loan principal balance are subtracted from the maturity value and the remaining balance comprises the whole-equity balance. The whole equity balance is used to pay the borrower's invested equity to the borrower. The borrower's invested equity comprises the borrower's initial down payment plus the total of all principal payments made under any first mortgage loan.

Preferably, where there is a first mortgage loan in addition to the SAM loan, the first mortgage prohibits negative amortization, whereby unpaid interest accumulates into the first mortgage principal balance. Where such negative amortization may be permitted, any accrual of the first mortgage principal balance over the term of the SAM loan must be deducted directly out of the borrower's invested equity and made available to the SAM lender in succeeding balance segments.

In addition to the borrower's initial down payment and principal payments, the borrower's invested equity may comprise any major home improvement expenses made by the borrower, such as for additions, pools, and the like. Optionally, the present system may limit the total dollar amount of major home improvement expenses which may accrue toward the borrower's invested equity, for example as a percentage of the initial purchase price, or as a multiple of the borrower's initial down payment. In this embodiment, the borrower recovers the equity invested in major improvements as a component of the borrower's invested equity balance. Any dividends from such equity investments may fund the SAM lender's accrued interest or the shared appreciation equity balance. In addition to recovering any such expenses and sharing in dividends the borrower also gets the direct benefit of such improvements during his ownership or occupancy of the real estate.

A more preferable embodiment, however, excludes any increase in borrower's equity based on major home improvements as well as for all normal and/or nominal maintenance expenses associated with upkeep of the real estate. Thus, major improvement, maintenance and repair expenses are born solely by the borrower. In this simplified embodiment, only payments toward the principal balance of any first mortgage loan will increase the borrower's equity.

After the borrower's invested equity is paid out of the whole-equity balance, the remaining balance comprises the total appreciation equity. The total appreciation equity is then used to pay the SAM lender's accrued interest, if sufficient. The SAM lender's accrued interest comprises the interest accrued over the life of the SAM loan at the SAM loan interest rate, which interest has been deferred from funding to maturity. The SAM interest preferably comprises simple interest on the original loan amount. The simple deferred accrued interest can be calculated as follows:

a=rᵢ·p·nₘ Formula 5

Where
a=Accrued SAM interest
rᵢ=SAM loan interest rate
p=SAM principal balance
nₘ=elapsed time from SAM loan origination to maturity

The simple appreciation mortgage interest rate may be based upon prevailing rates at the time of origination, as determined by any number of available and readily used indices, such as the prime rate, LIBOR, treasury indices, GSE bonds, or the like. The interest rate may be adjustable or fixed throughout the term of the SAM loan and may be as low as 0% and as high as allowed by law.

It should be appreciated that the SAM lender's interest in the accrued interest vests only after the priority interests, including the borrower's invested equity, have been paid. Because, unlike prior SAM loans, the present system defers all interest compensation until maturity and because the borrower's interest in the invested equity vests before the SAM lender's interest in the SAM accrued interest, if there is little or no appreciation in the value of the real estate, the SAM lender may receive little or no compensation over the life of the SAM loan.

Optionally, the SAM accrued interest may comprise compound interest, which may be used as a hedge by the SAM lender to shift the balance of prioritized payments in the SAM lender's favor. In the case of compound SAM interest, the SAM loan principal balance increases, in a negatively amortizing manner, due to an accumulation of unpaid SAM interest as no payments of principal or interest are due until maturity of the SAM loan. This compound, negatively amortizing SAM interest, in effect, funds the SAM lender's prioritized SAM loan principal balance at the expense of the funds available to pay the borrower's invested equity.

After the SAM loan accrued interest is paid out of the total appreciation equity balance, any remaining balance comprises the shared appreciation equity, comprising a lender's appreciation share and a borrower's appreciation share. Based on the previously described prioritized payment segments, the shared appreciation equity can be calculated as follows:

eₛₐ=(vₘ−f−p−e_{b}−a) Formula 6

Where
eₛₐ=shared appreciation equity balance
p=SAM principal balance
a=Accrued SAM interest
f=First mortgage loan principal balance
e_{b}=Borrower's invested equity
vₘ=Maturity value

Finally, the SAM lender's appreciation share is the balance calculated by multiplying the shared appreciation equity balance by the SAR. The SAM lender is entitled to this amount and the borrower is then entitled to the remaining funds.

x=eₛₐ·rₐ Formula 7

Where
x=SAM lender's appreciation share
eₛₐ=shared appreciation equity balance
rₐ=shared appreciation rate (SAR)

### EXAMPLE 3

The following example shows the present system being used to assign prioritized balance segments and distribute proceeds where the shared appreciation equity balance is a positive balance. This example corresponds to a scenario represented in FIG. 1.

Real estate purchase price=$500,000

Borrower's initial equity (down payment)=$50,000;

First Mortgage

Initial principal balance=$400,000

Loan to value=80%

Interest rate=7.0%

Term=30 years, fully amortizing

SAM Loan

Principal balance=$50,000; a 10% SAM loan to value

Expected annual rate of return=12%

Interest rate=8.0%; (simple interest)

Predicted housing appreciation rate=3.0%

Term=10 years.

Shared appreciation rate=20.35%

Real estate is sold after 5 years and 2 months (62 months) for $600,000 (maturity value)

Vesting and Distribution of Proceeds
1. The first mortgage loan principal balance of $376,062 gets paid to first mortgagee. The first mortgage loan outstanding principal balance remaining after 62 months. Any other closing costs and accrued and unpaid interest due and owing at the time of closing is paid by the borrower outside of the present system.
2. The SAM loan principal balance in the amount of $50,000 gets paid to the SAM lender.
3. The whole equity balance funds, in the amount of $173,938, comprising the maturity value ($600,000) minus the first mortgage principal balance ($376,062) minus the SAM principal balance ($50,000).
4. The borrower's invested equity in the amount of $73,938 next gets paid to the borrower. The borrower's invested equity comprises the principal paid on first mortgage loan ($23,938) over the life of that loan, plus the borrower's initial equity provided as a down payment ($50,000).
5. Total appreciation equity balance funds in the amount of $100,000. This is the balance remaining after paying the borrower's invested equity ($73,938) out of the whole-equity balance ($173,938).
6. Out of the available total appreciation equity, the SAM accrued interest in the amount of $21,320 is next paid to the SAM lender. The SAM interest is calculated by multiplying the SAM principal balance ($50,000) by the SAM interest rate (8.0%) and multiplying the result by the elapsed time since origination (5.33 years).
7. The shared appreciation equity balance funds in the amount of $78,680. This balance is calculated by subtracting the priority balances from the maturity value (Formula 6) ($600,000−$376,062−$50,000−$73,938−$21,320).
8. The lender's appreciation share, $16,011, gets paid to the SAM lender. This amount represents the shared appreciation equity balance ($78,680) multiplied by the SAR (20.35%).
9. The borrower's appreciation share, $62,668, finally gets paid to the borrower. The borrower receives 79.65% of the shared appreciation equity ($78,680).
10. The SAM lender's total compensation=$37,331 (comprising $16,011+$21,320)

This example shows the lender's actual annual return of 14.01% ($37,331/($50,000·5.33 years).

All costs of the sale of the real estate are borne by the borrower, and paid outside of the distributions described herein.

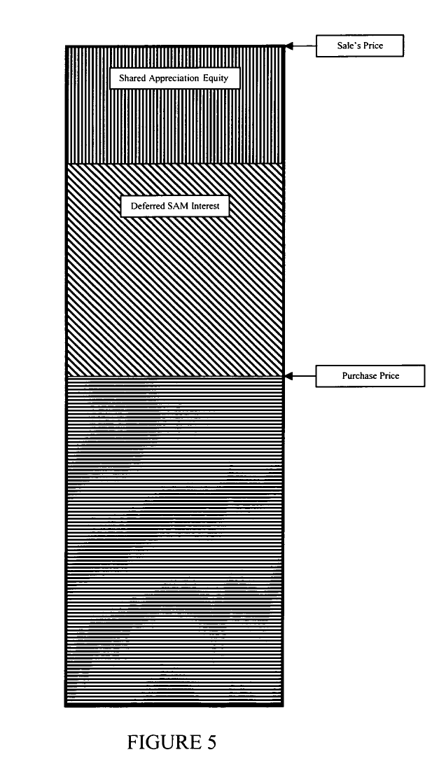

FIG. 5 illustrates how, for this example of a preferred embodiment where the SAM loan principal balance does not change over the life of the loan and where the borrower's invested equity is not increased by home improvements or the like, the SAM lender's total compensation (but not its appreciation share) will be based on the difference between the sale's price and the purchase price. Of course, if the appreciation in the real estate over the life of the loan is not sufficient to pay even the deferred accrued interest, there will be no shared appreciation equity balance at all, and the lender's accrued interest compensation will be diminished.

If the real estate has not appreciated in value, or has gone down in value as of the time of sale, then the proceeds of the sale are distributed according to the priority established by the present system until available funds are depleted. While the appreciation mortgage lender's entire interests are secured by the total value of the real estate asset, the appreciation mortgage lender is in a second lien position behind the first mortgage lender in terms of its security interest. Moreover, the financial instruments establishing the appreciation lender's compensation interests, and the borrower's payment obligations, determine that after the appreciation principal balance, the appreciation lender's compensation interests are subject to the availability of funds, according to the priority of the vested segments. Thus, for instance, if the real estate were sold for the same amount as the purchase price, or less, the borrower will not owe any appreciation interest at all, and will have had his home partly paid for at no cost.

### EXAMPLE 4

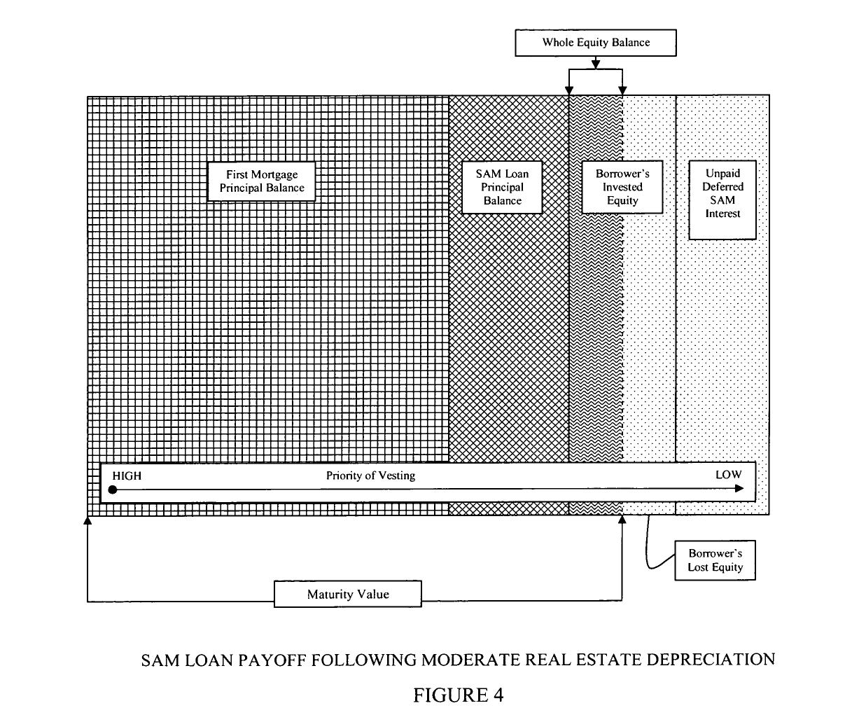

This example uses the same first and second loan parameters, except in this example the real estate is sold after 5 years and 2 months (62 months) for $490,000. This example corresponds to a scenario represented in FIG. 4.

Vesting and Distribution of Proceeds
1. The first mortgage principal balance of $376,062 paid to first mortgagee.
2. The SAM loan principal balance in the amount of $50,000 is next paid to appreciation mortgage lender.
3. The whole-equity balance funds in the amount of $63,938, comprising the maturity value ($490,000) minus the first mortgage obligations ($376,062) minus the SAM principal balance ($50,000).
4. The borrower's invested equity, totaling $73,938, gets paid up to the available whole equity balance, $63,938. Thus the borrower suffers a $10,000 loss.
5. Total appreciation equity=$0; the remaining balance segments all have zero balances as well.
6. The SAM loan's deferred, accrued interest in the amount of $21,320 is a total loss to the SAM lender. The SAM lender's total compensation is zero after 5.33 years. However, the SAM lender receives full return of the SAM loan principal balance.

As this example makes clear, the risks to borrower and SAM lender have been significantly shifted from prior art SAM loans. The system of prioritized balances entitles the borrower to his invested equity before the SAM lender is entitled to any compensation at all.

No Purchase, No Sale of Real Estate

Where the SAM loan is originated as a refinance or is otherwise originated any significant period of time after the real estate purchase has been completed, or if the purchase price is significantly discounted or inflated from the fair market value, it will be important to accurately assess the present value of the real estate as a basis for determining the borrowers initial equity and the shared appreciation equity, among other variables. Similarly, where the term of the SAM loan expires or there is a pre-payment event, the maturity value must be determined absent a fair market price sale of the real estate. The present value of the real estate may be determined at any point in time by means of an appraisal; by use of an index, for example a historical housing appreciation rate over a period of time; by a method well-known in the arts such as an automated valuation model, or AVM, or by any combination of the foregoing. Use of an AVM is preferred as a robust model can provide an accurate home valuation in seconds, and saves the time and expense involved in conducting an on-site appraisal.

Where the appreciation mortgage matures at the end of the term, without a sale, or if the borrower prepays the SAM loan, it is also necessary to calculate a payoff figure for any first mortgage to determine the first mortgage obligations. A payoff figure may be provided by the first mortgage lender or may be calculated using an amortization schedule can be used to determine the first mortgage obligations. In all other respects, the borrower's payment obligations are paid according to the prioritized payment schedule of the present invention.

### Description of a Method of Implementing the SAM Loan

The present invention also includes a method for implementing the appreciation mortgage loan system using a computer system. The present method may be accomplished through the use of a single computer or a networked computer system. Computers and computer systems themselves are well known in the arts. The method of the present invention, for the first time, employs computers to implement the current mortgage finance system. The method comprises using a computer system to input data, calculate the SAM lender compensation factors and to produce mortgage loan documents. At maturity, data may be entered to calculate payoff data and to formulate the distribution of proceeds according to the prioritized available balances.

The method of the present invention comprises a first data entry step, a second calculation step, a third document creation step, and a fourth SAM loan closing step. The data entry step comprises entering, with regard to the shared appreciation mortgage loan, borrower data, lender data, and loan variables into a computer system. The calculation step comprises calculating lender compensation factors by means of the computer system. Optionally, the calculation step may further comprise running different loan scenarios within feasible parameters of loan data to assess the optimum performance characteristics for a given loan at a given time. The document creation step comprises using the computer system to produce mortgage loan documents which create a shared appreciation mortgage loan employing the present shared appreciation mortgage system. The SAM loan closing step comprises recalling the loan file, entering maturity variables, calculating prioritized balance segments and outputting SAM lender compensation.

In a first step, the borrower data, lender data, and system variables are entered. The borrower data comprises the information about the borrower which information is typically collected on mortgage application forms, for example: the borrower's name, address, social security number, and date of birth. The lender data comprises information about the lending entity, for example its name and address and any other customary information. The loan variables comprise the terms of the loan which may be selected on a loan by loan, a lender by lender, or a borrower by borrower basis, for example: the term, the loan principal amount, the real estate value at origination, the loan to value, and the housing appreciation rate. The lender compensation factors comprise the SAR, the SAM interest rate, and the lender's expected rate of return. Together, the loan variables and the lender compensation factors comprise the system variables.

In a second calculation step, the computer system may be directed to output a variety of mortgage loan scenarios illustrating the results of adjusting system variables, within specified parameters. This output may be used by the lender in deciding whether to originate a loan according to a particular scenario and may, optionally, be shared with the borrower toward educating the borrower about the nature of the SAM loan and various loan options which the SAM lender may-be willing to offer.

The lender and the borrower may negotiate any one or several of the system variables. During the calculation step, many of the loan variables and each of the compensation factors may be selected and adjusted to deliver a desired outcome for one of the other system variables, typically the lender's expected return rate.

The lender data, the borrower data and the system variables are all stored automatically by the computer system as a loan file in the computer system memory in a step which may occur at any stage and at multiple stages throughout the implementation of the mortgage finance system.

A third documentation step produces the required documents which will make the agreements of the mortgage finance system legally binding and enforceable by and on the parties. The present method employs a computer system which is capable of importing the pertinent borrower data, lender data and system variables, previously entered and/or calculated, into a document processing software application which populates loan documents with a written description of the selected, agreed upon loan features. The loan documents produced will comprise a note and a mortgage deed, each of which may be produced according to the requirements of the laws and regulations concerning shared appreciation mortgage transactions. The loan documents may be distributed, executed, recorded and otherwise handled according to requirements outside the scope of the present invention.

In a fourth SAM loan closing step, the loan file is recalled upon maturity for the further entry of maturity variables and the calculation of the prioritized balance segments. The maturity variables comprise the maturity value; the elapsed time since origination; the accrued deferred SAM interest; any allowed increase or decrease in borrower's invested equity or SAM loan principal balance; and any first mortgage principal balance. Following the entry of the maturity variables, the computer system is then employed to calculate the prioritized balance segments. Upon calculation of the balance segments, the computer system will provide output indicating the payoff protocol for all of the balance segments, including the total amounts due and owing to the SAM lender upon closing of the SAM loan.

While particular embodiments of the present invention have been set forth for the purposes of illustration and description, the foregoing description should not be deemed a limitation of the invention claimed herein. Accordingly, various modifications, adaptations, and alternatives may occur to one skilled in the art without departing from the spirit and scope of the present invention. The appended claims are intended to cover all such modifications, adaptations, and alternatives.

The invention claimed is:

1. A shared appreciation mortgage loan finance system which establishes for a shared appreciation mortgage loan: a term (n); an interest rate (rᵢ); a value of a real property at the approximate time of origination of said shared appreciation mortgage loan (vₒ); a borrower's invested equity (e_{b}); a loan to value (k); a predicted annual housing appreciation rate (rₕ); an expected average annual rate of return (rₑ); a shared appreciation rate (rₐ); and vested appreciation mortgage loan balances comprising: a shared appreciation mortgage loan principal balance (p); a first mortgage loan principal balance (f); a whole-equity balance; a borrower's invested equity balance (e_{b}); a shared appreciation equity balance (eₛₐ); a shared appreciation mortgage loan accrued interest balance (a); a shared appreciation equity balance (eₛₐ); and a shared appreciation mortgage lender's share (x) of said shared appreciation equity balance; wherein said system provides for deferral of all payments of shared appreciation mortgage loan principal and said shared appreciation mortgage loan accrued interest until an end of said term.

2. The system of claim 1 wherein said shared appreciation rate is determined by the formula:
$${r}_{a} = \frac{( p \cdot {r}_{e} \cdot n ) - ( p \cdot {r}_{i} \cdot n )}{( {v}_{o} \cdot ( 1 + {r}_{h}^{n} ) - {v}_{o} ) - ( p \cdot {r}_{i} \cdot n )}$$

3. The system of claim 2 wherein said shared appreciation mortgage lender's share (x) is calculated by the formula
x=eₛₐ·rₐ.

3. The system of claim 1 wherein a maturity value (vₘ) of said real property is divided into prioritized segments comprising a first mortgage obligation segment, a shared appreciation mortgage loan principal balance segment, a whole equity balance segment comprising a borrower's invested equity balance segment and a total appreciation equity balance segment comprising an accrued shared appreciation mortgage loan interest segment and a shared appreciation equity segment comprising a lender's appreciation share segment and a borrower's appreciation share segment.

4. The system of claim 3 wherein said maturity value funds said prioritized segments in the following order: first said first mortgage obligation segment; second said shared appreciation mortgage loan principal balance segment; third said whole equity balance segment; fourth said borrower's invested equity balance segment; fifth said total appreciation equity balance segment; sixth said accrued shared appreciation mortgage loan interest segment; seventh said shared appreciation equity segment; eight, said lender's appreciation share; and ninth said borrower's appreciation share segment.

5. The system of claim 4 wherein said shared appreciation equity balance is determined by the formula: eₛₐ=(vₘ−f−p−e_{b}−a)

6. A method for implementing a shared appreciation mortgage loan using a computer system comprising: a first data entry step, a second calculation step, a third document creation step, and a fourth SAM loan closing step.
